(19) United States
(12) Patent Application Publication
(10) Pub. No.: US 2005/0211656 A1
(43) Pub. Date: Sep. 29, 2005

(54) Bottle cap with built-in magnification

(76) Inventor: Frank Muir, Glasgow (GB)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/807,411

(22) Filed: Mar. 24, 2004

(51) Int. Cl. B65D 51/00; G02B 27/02

(52) U.S. Cl. 215/228; 359/802

(57) ABSTRACT

A bottle cap including an integral lens fully covering the top portion of a bottle cap. The radius of curvature of the lens is dependant on the size or diameter of the bottle cap. This bottle cap is particularly desirable for use on a medicine bottle, as it can provide the user of the medication a tool through which to better view the instructions for the medication to avoid errors in dosage, mixing medications with inappropriate substances, or ingesting medication that is not compatible with a physical condition. The bottle cap is manufactured using a method comprising pressing a single piece of transparent or translucent plastic, preferably using a stamping machine, to form upper and lower convex surfaces of a top portion of the bottle cap, wherein at least one of the upper and lower surfaces is convex, comprising the built-in magnification apparatus, and an annular bottle engaging portion extending from a perimeter of the top portion of the bottle cap.

### BACKGROUND OF THE INVENTION

1. Field of the Invention

The present invention generally relates to a magnification apparatus incorporated into a bottle cap and more specifically to a magnification apparatus and lid for a bottle molded concurrently into a single unit wherein the lens has a radius of curvature that varies in relation to the size or diameter of the bottle cap.

2. Description of the Prior Art

Bottles, despite their contents, often require some text on the bottle in order to label, promote, or explain the contents of the bottle. Depending on the contents, some bottles require a greater amount of text than others. A medicine bottle, for example, is a comparatively small bottle, but one that requires a large amount of text as all medications, sold by prescription or over the counter, come with a series of instructions and warnings which are of critical importance. Such instructions include the appropriate quantity of medicine to ingest/use, a description of the appropriate time intervals to use the medication, and other precautionary measures associated with a particular medication to ensure that the medication is an effective remedy and does not subject the user or patient to physical and/or mental harm. As these instructions are important, the inclusion of these warnings on a paper separate from the medication itself is not an adequate solution. Similarly, other bottles may require that certain text is included on the bottle's surface.

In order to accommodate all of the necessary text, labels on bottles, particularly medicine bottles, have become very small, and as a result, not easily legible, particularly to patients with imperfect eye sight. As such, if a method for reading the labels is not readily provided for those with sight impairments, these patients may forgo reviewing the directions and accidentally take an inappropriate dose that may not effectively treat the patient's particular ailment, and in some circumstances, prove harmful or even fatal.

Various solutions have been proposed to solve this serious problem. U.S. Pat. No. 5,760,975 proposes a solution in which an independent magnifying lens is secured within a lid of a bottle. The intention is that the user could take the cap off of the bottle and then read the directions using the bottle's cap. Although this solution would be effective in aiding the user to read the labels and instructions, other issues could prove problematic. For example, as the lens is attached to the cap as a separate piece, it is possible that the two components could become separated. Such an occurrence could lead to a loss of the medication inside, contamination of the medicine inside, or even ingestion of the medication by someone other than the prescribed recipient. As such, U.S. Pat. No. 5,760,975 also suggests an alternate configuration, wherein the cap is designed to have the lens attachment as a secondary cap, fitting over a generic bottle top to avoid the potentially severe consequences of the lens becoming displaced from the cap fitting.

In another instance, detailed in U.S. Pat. No. 6,278,545, a magnifying lens is molded or manufactured into the cap of the medicine bottle and can cover the entire bottle cap or just a portion thereof. The focal length of the lens is noted to be longer than the length of the packaging to avoid any problems caused by light becoming concentrated at the focal point, however, no mention is made for adjusting the lens curvature based on the diameter of the bottle cap to aid in the legibility of the labels through the lens. Further, as molding is used to manufacture the lens, the variant thickness inherent to the lens' shape could lead to warping of the lens during the plastic's cooling period. In effect, the text may become distorted to a state of illegibility similar in degree to viewing the text without any magnification at all.

A further problem, particularly with medicine bottles, is making sure that the content of the bottle is consistent with the labeling and that the pharmacist has filled the medication correctly. This problem is addressed by U.S. Pat. No. 6,386,367 which uses a modified lid and label system. The lid is modified to have an internal compartment that protrudes down through the top of the bottle when the lid closes the bottle. This compartment is used to hold one pill that is of the same kind as all other pills inside the bottle. A lens is fitted into the lid over this compartment, so that the user can view the pill through the magnifying lens. The label is printed to include a picture of the pill that matches the identification of the contents on the bottle. However, by adding information to the label, room for other warning and dosage information may be forced to become even smaller. The lens used in this invention is also limited to the viewing of the pill inside the interior compartment and cannot aid in deciphering the label text.

### SUMMARY OF THE INVENTION

It is therefore an object of the present invention to provide a singular apparatus to serve as a sealing means for a bottle and as a lens for reading instructions located on the bottle or the text in associated packaging.

In order to accomplish these and other objects of the invention, a method of making a bottle cap with a built-in magnification feature is provided, comprising the step of pressing a piece of clear plastic into the shape of a bottle cap having a top portion and an annular bottle engaging portion, the top portion having upper and lower surfaces wherein a perimeter of the upper and lower surfaces extends to the annular bottle engaging portion, the upper and lower surfaces providing optical magnification of objects viewed through the top portion of the cap, wherein at least one of the upper surface and lower surface is convex.

Further, a bottle with a bottle cap that provides built in magnification is described, comprising a bottle; a bottle cap having a top portion and an annular bottle engaging portion, the bottle engaging portion being secured to the bottle, and rotatable about an axis passing through the bottle; and a hinge associated with the bottle cap which connects the top portion and the bottle engaging portion which permits the top portion to be moved from a top of the bottle to confront a side of the bottle, the top portion having at least one convex surface and forming a magnifying lens which magnifies objects on the side of the bottle.

Further still, a bottle with a bottle cap that provides built in magnification will be provided, the bottle comprising a top, a bottom and a non-circular side having at least one flat side wall portion; a bottle cap having a top portion and an annular bottle engaging portion secured to said bottle; and a hinge associated with the bottle cap which connects the top portion and the bottle engaging portion which permits the top portion to be moved from a top of the bottle to confront the flat side wall portion of the bottle, the top portion having at least one convex surface forming a magnifying lens which magnifies objects on the flat side wall of the bottle.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1 and 2 are perspective views of bottles having different diameters utilizing the invention.

FIG. 3 shows an exemplary use of the invention.

FIG. 4 is a sectional view of FIG. 1 at line “A”.

FIG. 5 is a sectional view of FIG. 2 at line “B”.

FIGS. 6a, 6b, and 6c show sectional views of possible methods for attaching the lid to the bottle.

FIGS. 7 and 8 show alternate embodiments of the invention using a flip top.

FIGS. 9, 10, and 11 show exemplary alternate embodiments of the invention.

### DETAILED DESCRIPTION OF A PREFERRED EMBODIMENT OF THE INVENTION

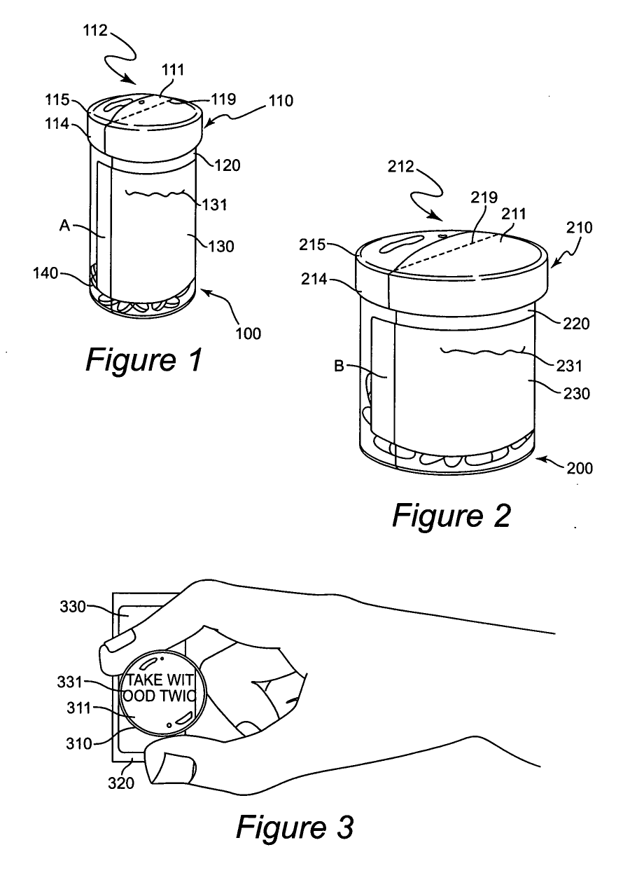

Referring now to the drawings, and more particularly to FIG. 1, there is shown a bottle assembly 100 with an instruction label 130 and a bottle cap 110. The bottle cap 110 has an integral lens 111 comprising a substantial region of the bottle cap's top portion 112. The bottle assembly 100 may have one or more instructional labels 130 preferably adhered to the bottle 120. The instructional label 130 contains text 131 with directions and precautions about how to take the medicine 140 inside the bottle assembly 100.

Pill bottles 100, assuming an average height of approximately 7.6 cm (3.0″), range in diameter from approximately 1.6 cm (0.63″) to 5.5 cm (2.17″) wide (representatively shown in FIGS. 1 and 2 as a smaller diameter 119 and a larger diameter 219, respectively). As a result, the surface area provided on a bottle may be as little as 38.3 cm² (5.93 in²) or as much as 131.6 cm² (20.40 in²). The smaller bottle 120 might only fit a label of approximately 7.6 cm×5.0 cm (3.0″×2.0″) whereas a larger bottle 220 might accommodate a label as large as 7.6 cm×17.3 cm (3.0″×6.8″). Within this limited surface region, the labels must include the patients name, the medicine's name, strength per pill, the doctors name, dosage information, refill information, consumption information (e.g. take with food), often multiple warnings on separate labels (e.g. may cause drowsiness, do not take if pregnant, do not consume alcohol, do not operate heavy machinery, etc.) Generally pharmacy information such as the logo and phone number are also included on the label. With all of this information to display, the type is generally very small, and can be difficult to read.

FIG. 3 shows how the lens 311, integrated into the top portion of the bottle cap 310, can be used to magnify a label's text 331. Upon opening the bottle, the user automatically has a magnifying apparatus in hand, and will not need to locate glasses or other alternate method of magnification. With a readily accessible, built-in magnification tool 311, people who have trouble reading the information on the labels will be more likely to read the instructions 331, and less likely to accidently misuse their medication, or miss important warnings about their medicine.

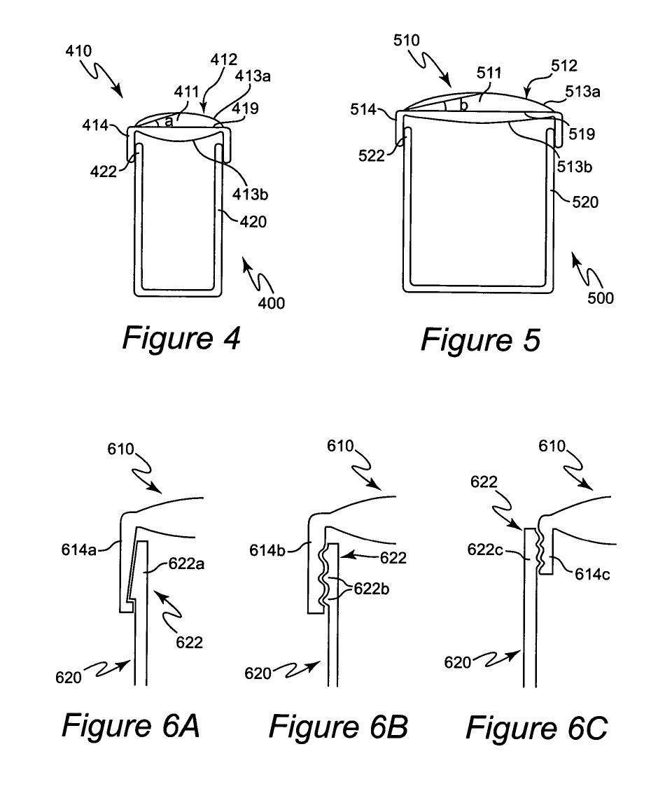

The lens 411 is preferably convex on both the upper surface 413a and lower surface 413b as shown in FIG. 4, forming the top portion 412 of the bottle cap. However, the bottle may be flat on either the top or bottom surface, provided that the other surface remains convexly curved. FIG. 11 demonstrates an embodiment of the lens wherein only the bottom surface is convexly curved and the top portion is flat. This embodiment may be particularly useful for stacking bottles, or other objects, on top of the bottle's flat upper surface.

Whether there is one convex surface, or two, the curvature of a convex surface of the lens will vary depending on the diameter 419 of the bottle cap 410 and has a focal length longer than the height of the bottle, and preferably a focal length that is at least one and a half times the height of an average bottle. Ideally, a tooling set for a cap of any given diameter will provide a radius of curvature of the lens having a focal length that is suitable to a wide range of bottle heights, whereby the focal point is never located within the volume of the bottle. Bottle caps with a larger diameter 219, such as bottle cap 210 shown in FIG. 2, have a lens 211 with a larger curvature radius (flatter slope from edge to center) than bottles with a smaller diameter 119 such as bottle cap 110 shown in FIG. 1 having a smaller curvature radius (greater slope from edge to center) on convex surfaces. This can be seen in cross-section A of FIG. 1 and cross-section B of FIG. 2, shown in FIGS. 4 and 5 respectively, where ∠a is greater than ∠b. By determining the lens' radial curvature based on the bottle cap diameter, different levels of magnification may be achieved by the bottle cap, e.g. smaller bottles may have caps with greater magnification.

As illustrated in FIG. 1, the upper convex surface and lower convex surface of the top portion 112 are surrounded by a perimeter 115 extending to an annular bottle engaging portion 114. FIG. 4 provides a more defined image of the upper convex surface 413a and lower convex surface 413b of the top portion 112 (FIG. 1). The two surfaces are preferably formed having the same convex radius of curvature, but this feature is not required. As shown in FIGS. 6a, 6b, and 6c, the annular bottle engaging portion includes a lid wall and may include an inwardly projecting hook region 614a at the base of the lid wall as shown in FIG. 6a, interior thread engaging members 614b as shown in FIG. 6b; exterior thread engaging members 614c as shown in FIG. 6c, or, alternatively, a child safety lock, or other method where the bottle cap 610 is entirely removable from the bottle portion 620. The top of the bottle portion 622 includes a bottle cap engaging portion 622a, 622b, or 622c which is suitably paired with the respective bottle engaging portion 614a, 614b, or 614c of the bottle cap 610.

The bottle cap may be transparent or translucent, and may have opaque portions providing that such portions do not interfere with the viewing of text through the lens. The cap is preferably formed from acrylic, polyester, polyethelene, or a variation of one of these plastics or other material suitable for creating the form described below. A method is provided for manufacturing a bottle cap with built-in magnification wherein the lens of the bottle cap is formed from a single piece of plastic which is pressed in a tooling system with a concave region on at least one of the top and bottom tools. The radius of curvature of the concave portion of one or both of the tools is based on the diameter of the bottle cap, having a focal length that is preferably a minimum distance of one and a half times the height of the bottle. The pressing step is preferably performed using a stamping machine whereby the resulting upper and lower convex surfaces are formed having a perimeter extending to the annular bottle engaging portion 114. The annular bottle engaging portion 114 of the bottle cap and the lens 111 are formed from a single piece of plastic, preferably formed simultaneously, during the stamping process; or, alternatively, prior to or following lens formation, or a combination thereof depending on the attachment method (e.g. thread engaging members, projecting hook regions, etc.) for connecting the annular bottle engaging portion 114 to the cap engaging portion of the bottle 120.

Further, the method may include the step of separating the top portion 112 and the annular portion 114 along an arc while maintaining a connection between the two members along a straight section whereby the top portion is rotatably movable in a hinge-like fashion.

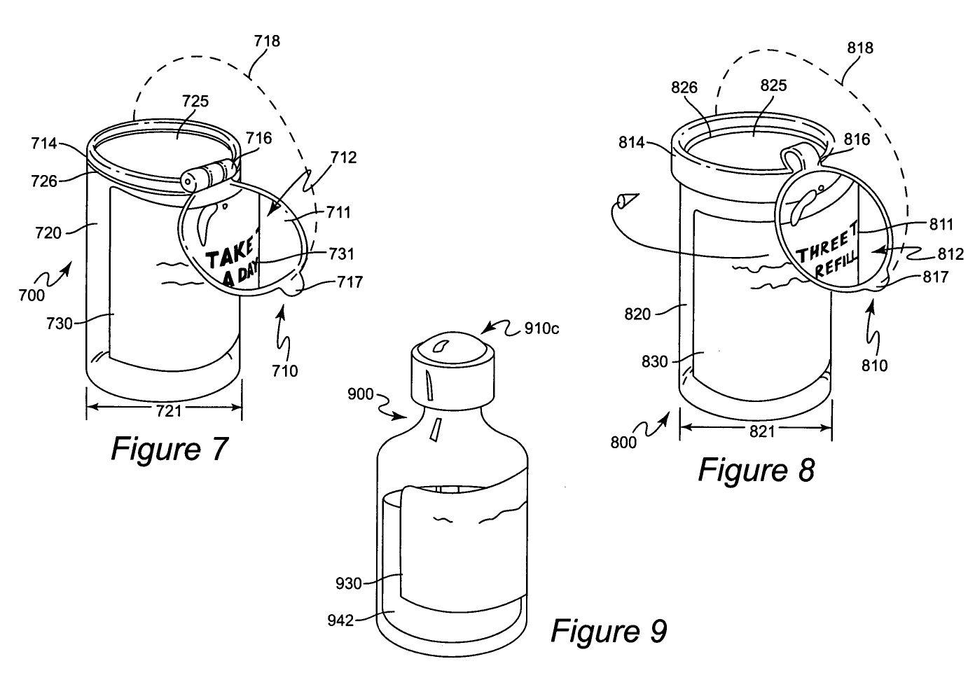

FIG. 7 shows an alternate embodiment of the invention, wherein the top portion 712 with integrated lens 711 is directly attached to the annular bottle engaging portion 714 by a hinge-pin assembly 716 and fastening mechanism 717. The fastening mechanism 717 is disengaged to uncover the open end of the bottle 725. The top portion 712 has a fully pivotal range of motion along an arc 718 so that the lens 711 can be used to read the labels 730 on the surface of the bottle 720 when the bottle assembly 700 is open, as shown in FIG. 7. The annular bottle engaging portion 714 is preferably rotatable around the perimeter 726 of the bottle 720.

FIG. 8 shows another alternate embodiment of the invention which also allows for a range of motion of the lens 811 about the perimeter 826 of the bottle while following an arc-shaped path 818. This is achieved by having the top portion 812 attached to the annular bottle engaging portion 814 by a length of plastic constituting a hinge 816. The annular bottle engaging portion 814 is attached to the bottle 820 in such a way that it can be spun on the bottle without coming off. In this embodiment and that of FIG. 7, one hand can easily be used to open the bottle and use the lens to magnify the majority of text on the instruction label(s) while holding the bottle at an appropriate viewing angle. As such, FIG. 7 and FIG. 8 provide flip-top magnification bottle systems 700 and 800 for people with limited mobility as well as limited eyesight. A flip-top bottle may be easily operated by someone with use of only one functional arm. For example, patients with a broken arm, hand, collarbone, etc. taking medication for pain or other ailment are likely to find such a formation highly preferable.

It is important to recognize that although the invention is generally shown in the configuration of a pill bottle (as in FIGS. 1 through 8), the bottle is not limited to a pill bottle structure and may hold contents other than medicine or solids and the bottle itself may be similarly or differently shaped. FIG. 9 shows an alternate embodiment of the invention. A bottle assembly 900 containing a liquid 942 is shown. The bottle cap 910C, which is not necessarily specific to this configuration, contains a colored pigment. The colored pigment can be used to detect text which is otherwise illegible on the bottle. Such a lid might have implications in the beverage industry for contests, or fun applications for children's products.

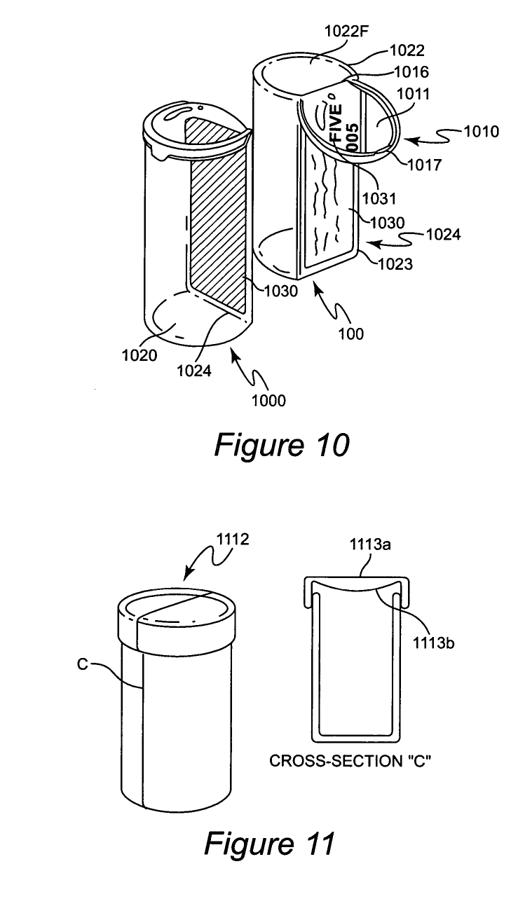

FIG. 10 shows another alternate embodiment of the invention using a flip top system. In this embodiment, the bottle assembly 1000 has a non-circular footprint, and the bottle cap 1010 and the bottle 1020 are integrally formed into a single unit 1000. The bottle assembly 1000 preferably has one flat side 1024 and is preferably formed out of polypropelene or other plastic that can undergo significant movement without fatigue or cracking along the hinge 1016. The label 1030 can be placed on this flat side 1024, with the built-in folding hinge 1016 running along the top 1022F of the flat side. This configuration may be constructed to taper at the bottom 1023 of the bottle and be wider at the top 1022 such that opened empty bottles 1000a may nest to save storage space within the pharmacy and during shipping of the bottles to the pharmacy or elsewhere.

FIG. 11, as previously discussed, also shows an alternate embodiment of the invention having a flat upper surface 1113a of the top portion 1112 and a convex lower surface 1113b as emphasized in cross-section C. This embodiment may be particularly useful as it allows the bottles to be stacked.

In view of the foregoing, the above described invention provides a lens integrally formed into the lid of a bottle, particularly a medicine bottle, providing the user of the medication a tool through which to better view the instructions for the medication to avoid errors in dosage, mixing medications with inappropriate substances, or ingesting medication that is not compatible with a physical condition, as well as a method for manufacturing a bottle cap with built-in magnification using stamping.

While the invention has been described in terms of a single preferred embodiment, those skilled in the art will recognize that the invention can be practiced with modification within the spirit and scope of the appended claims.

1. A method of making a bottle cap with a built-in magnification feature, comprising the step of pressing a piece of plastic into the shape of a bottle cap having a top portion and an annular bottle engaging portion, said top portion having upper and lower surfaces wherein at least one of said upper and lower surfaces is convex and having a perimeter that extends to said annular bottle engaging portion, said upper and lower surfaces providing optical magnification of objects viewed through said top portion.

2. The method of claim 1 wherein said pressing step is achieved using a stamping machine.

3. The method of claim 1 wherein said annular bottle engaging portion includes thread engaging members.

4. The method of claim 1 wherein said annular bottle engaging portion includes a lid wall with an inwardly projecting hook region at its base.

5. The method of claim 1 further comprising the step of separating said top portion and said annular portion along an arc while maintaining a connection between said top portion and said annular portion along a straight section, said top portion being rotatably moveable in hinge like fashion along said straight section.

6. The method of claim 1 further comprising the step of selecting a radius of curvature for said upper and lower convex surfaces based on a diameter of said bottle cap.

7. The method of claim 6 wherein said upper and lower surfaces are convex and having an equal radius of curvature.

8. The method of claim 6 wherein said upper surface and said lower surface have different radii of curvature of their convex surfaces.

9. The method of claim 6 wherein said upper surface is flat and said lower surface is convex.

10. The method of claim 1 wherein said piece of plastic is transparent.

11. The method of claim 1 wherein said piece of plastic is translucent.

12. A bottle with a bottle cap that provides built in magnification, comprising:
a bottle;
a bottle cap having a top portion and an annular bottle engaging portion, said bottle engaging portion being secured to said bottle, and rotatable about an axis passing through said bottle; and
a hinge associated with said bottle cap which connects said top portion and said bottle engaging portion which permits said top portion to be moved from a top of said bottle to confront a side of said bottle, said top portion having at least one convex surface and forming a magnifying lens which magnifies objects on said side of said bottle.

13. The bottle and bottle cap of claim 12 wherein said hinge includes a hinge pin assembly.

14. The bottle and bottle cap of claim 12 wherein the hinge is a length of plastic extending from said annular bottle engaging portion to said bottle cap.

15. The bottle and bottle cap of claim 12 further comprising means for detachably holding said top portion at said top of said bottle.

16. A bottle with a bottle cap that provides built in magnification, comprising:
a bottle, said bottle having a top, a bottom and a non-circular side having at least one flat side wall portion;
a bottle cap having a top portion and an annular bottle engaging portion, said bottle engaging portion being secured to said bottle; and
a hinge associated with said bottle cap which connects said top portion and said bottle engaging portion which permits said top portion to be moved from a top of said bottle to confront said flat side wall portion of said bottle, said top portion having at least one convex surface and forming a magnifying lens which magnifies objects on said flat side wall of said bottle.
